(19) United States
(12) Patent Application Publication
(10) Pub. No.: US 2014/0272439 A1
(43) Pub. Date: Sep. 18, 2014

(54) LOW EMBODIED ENERGY WALLBOARD

(71) Applicant: Serious Energy, Inc., Sunnyvale, CA (US)

(72) Inventors: Sunder Ram, Sunnyvale, CA (US); Russ Lampert, Sunnyvale, CA (US); Nick Olmsted, Sunnyvale, CA (US)

(21) Appl. No.: 13/844,077

(22) Filed: Mar. 15, 2013

(51) Int. Cl. C04B 7/345; B28B 5/00; B32B 13/08; C04B 7/14; C04B 7/28

(52) U.S. Cl. CPC C04B 7/345; C04B 7/14; C04B 7/28; B32B 13/08; B28B 5/00
USPC 428/452; 106/789; 106/705; 106/801; 106/638; 524/2; 524/8; 106/672; 428/537.7; 83/14; 264/299

(57) ABSTRACT

Low embodied energy wallboards and methods for forming same are disclosed. A wallboard can include at least one industrial material in an amorphous phase and at least one alkali-activating agent. The amorphous phase industrial material can be slag, fly ash, silica fume, and/or lime kiln dust. The alkali-activating agent can be calcium oxide, magnesium oxide, potassium hydroxide, sodium hydroxide, calcium hydroxide, calcium carbonate, potassium carbonate, sodium carbonate, sodium sesquicarbonate, sodium silicate, calcium silicate, magnesium silicate and/or calcium aluminate. Additional wallboard components can include water, a foam filler, paper, industrial material in a crystalline phase, and/or polyethylene fibers, polypropylene fibers, and/or other synthetic fibers.

### TECHNICAL FIELD

The present disclosure relates to wallboards, and more particularly to compositions for wallboard cores and processes that reduce the amount of energy required to manufacture wallboards.

### BACKGROUND

The process to manufacture gypsum wallboard is by some accounts over 100 years old. Gypsum wallboard is used in the construction of residential and commercial buildings to form interior walls and ceilings and also exterior walls in certain situations. Because it is relatively easy to install and requires minimal finishing, gypsum wallboard is the preferred material to be used for this purpose in constructing homes and offices.

Gypsum wallboard consists of a hardened gypsum containing core surfaced with paper or other fibrous material suitable for receiving a coating such as paint. It is common to manufacture gypsum wallboard by placing an aqueous core slurry comprised predominantly of calcined gypsum between two sheets of paper thereby forming a sandwich structure. Various types of cover paper or similar functioning member are known in the art. The aqueous gypsum core slurry is required to set or harden by rehydration of the calcined gypsum, usually followed by heat treatment in a dryer to remove excess water. After the gypsum slurry has reacted with water present in the aqueous slurry, set, and dried, the formed sheet is then cut into required sizes. These and other steps concerning methods for the production of gypsum wallboard are generally well known in the art.

A conventional process for manufacturing the core composition of gypsum wallboard initially includes premixing dry ingredients in a high-speed, continuous mixing apparatus. The dry ingredients often include calcium sulfate hemihydrate (i.e., stucco), an accelerator, and an antidessicant (e.g., starch). The major ingredient of the gypsum wallboard core is calcium sulfate hemihydrate, commonly referred to as “calcined gypsum,” “stucco,” or “plaster of Paris.” The calcination or dehydration step in the manufacture of stucco is performed by heating the land plaster which yields calcium sulfate hemihydrate and water vapor. This calcination process step is performed in a “calciner,” of which there are several types known by those of skill in the art. The calcining process itself is energy intensive. Several methods have been described for calcining gypsum using single and multi-staged apparatus, as described in U.S. Pat. No. 5,954,497, which is incorporated by reference herein in its entirety and for all purposes. Calcined gypsum reacts directly with water and can “set” when mixed with water in the proper ratios.

Gypsum wallboard requires significant energy to produce, as noted and discussed further in U.S. Pat. No. 8,337,993 (“the '993 patent”), which is incorporated by reference herein in its entirety and for all purposes. The term “embodied energy” used herein may be defined as the total energy required to produce a product from the raw materials stage through delivery of finished product. As further discussed in the '993 patent, drying gypsum, calcining gypsum, and drying the boards require considerable energy. Thus the embodied energy of gypsum, and the resultant greenhouse gasses emitted from its manufacture, is very high. However, few other building materials exist today to replace gypsum wallboard. Given modern concerns about climate change and energy conservation, it would be desirable to manufacture wallboard which requires dramatically less energy to make during manufacturing.

Although many systems and methods for manufacturing wallboard have generally worked well in the past, there is always a desire for improvement. In particular, what is desired are wallboard compositions and manufacturing techniques that use dramatically less energy to make during manufacture. There is a need also for substantially reducing or eliminating the energy intensive calcining and drying steps that are common to gypsum wallboard manufacturing.

### SUMMARY

It can be an advantage of the present disclosure to provide improved wallboard compositions and methods for manufacturing same using dramatically less energy. This can be accomplished at least in part by enabling the setting and drying of wallboard material described such that it is possible to use industrial material in an amorphous phase. In addition, an energy saving wallboard can also be manufactured through the use of hot water combined with industrial material in an amorphous phase and an alkali-activating agent.

The present disclosure provides wallboard compositions and their methods of manufacture. It shall be understood that different aspects of the disclosure can be appreciated individually, collectively or in combination with each other.

In accordance with one aspect of the present disclosure, new methods of manufacturing novel wallboards are provided. These structures may be described as low embodied energy wallboards that can provide ecological solutions to the ever growing demand for sustainable building and construction materials. The resulting novel and ecological wallboards provided in accordance with this aspect of the disclosure can, for example, replace gypsum wallboards (referred to as gypsum boards or plaster boards) or water-resistant cement boards in most applications. It shall be understood that these methods can also be applied and used to manufacture other building materials such as roof tiles, deck tiles, floor tiles, sheathing, cement boards, masonry blocks, bricks and other similar building materials.

In various embodiments, a wallboard may comprise at least one industrial material in amorphous phase selected from the group consisting of slag, fly ash silica fume, and lime kiln dust; and the addition of at least one alkali-activating agent.

In various embodiments, a wallboard comprises at least one industrial material in amorphous phase selected from the group consisting of slag, fly ash, silica fume, and lime kiln dust; at least one industrial material in crystalline phase selected from the group consisting of slag, fly ash silica fume, lime kiln dust; and also the addition of at least one alkali-activating agent.

In some embodiments, a wallboard comprises at least one industrial material in amorphous phase selected from the group consisting of slag, fly ash, silica fume, and lime kiln dust; at least one industrial material in crystalline phase selected from the group consisting of slag, fly ash, silica fume, and lime kiln dust; and also the addition of at least one alkali-activating agent dissolved in hot water.

Wallboards provided in accordance with this disclosure are fabricated with a significant reduction in the embodied energy associated with the wallboards, thus substantially reducing greenhouse gas emissions that harm the environment.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed inventive wallboards and methods of manufacture thereof. These drawings in no way limit any changes in form and detail that may be made to the disclosure by one skilled in the art without departing from the spirit and scope of the disclosure.

FIG. 1 provides a flowchart of an exemplary method of manufacturing gypsum drywall, particularly that which consumes substantial amounts of energy.

FIG. 2 provides a flowchart of an exemplary method of manufacturing low embodied energy wallboards that require substantially less energy to produce according to one embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The novel apparatuses and processes as described herein are for wallboard and manufacturing wallboard so as to eliminate the most energy intensive traditional processes and materials in the manufacture of gypsum wallboard. Such energy intensive processes can include gypsum mining, drying, calcining, and/or board or finished product drying, among others. These new devices and processes allow wallboard to be formed from industrial materials and non-calcined materials that are plentiful and safe, and which can react naturally to form a strong board that is also fire resistant. Wallboard may be produced to meet both interior and exterior requirements.

Turning first to FIG. 1, a flowchart of an exemplary method of manufacturing gypsum drywall is provided. The method shown depicts the major steps in a typical process to manufacture gypsum wallboard. After a start step 100, process steps can include crushing the gypsum at step 101, drying the gypsum at step 102, calcining the gypsum at step 103, mixing into a slurry in step 104, forming and cutting boards at step 105, and drying the boards at step 106, after which the method ends at an end step 107. As shown in FIG. 1, three of the illustrated steps (step 102: drying gypsum, step 103: calcining gypsum, step 106: drying the boards) in the manufacture of gypsum wallboard require considerable energy. Thus the embodied energy of gypsum, and the resultant greenhouse gasses emitted from its manufacture, are very high.

### Wallboard Materials

A preferable embodiment provides low embodied energy wallboards containing a core having greater than 50% industrial material, and an alkali-activating agent. In some embodiments, the amount of industrial material will be much higher than 50%, noting that the energy savings increase as the actual material content approaches 100%. The industrial material may include or be derived from blast furnace slag, steel slag, other types of slag, fly ash, silica fume, and lime kiln dust, or any combination thereof. A variety of one or more alkali-activating agents may be selected for various embodiments herein, including but not limited to the following: oxides, hydroxides, carbonates, silicates or aluminates; calcium oxide, magnesium oxide, potassium hydroxide, sodium hydroxide, calcium hydroxide, calcium carbonate, potassium carbonate, sodium carbonate, sodium sesquicarbonate, sodium silicate, calcium silicate, magnesium silicate or calcium aluminate, among other possible agents.

In making low embodied energy wallboards, it may be preferable to include powdered additives. These additives include agents or compounds for retarding, accelerating or modifying pH. Moreover, reactionary or adhesive components can be also added or mixed together at the start of a particular manufacturing process or processes selected to be used to form the low embodied energy wallboards. Prior to the addition of liquids, such as water, this mix of powders may be referred to or called the “dry mix.” In some embodiments, a dry mix of powders is prepared by mixing amorphous blast furnace slag, calcium hydroxide, an accelerator and synthetic fibers to form the dry mix. The dry mix can then be added to hot water that contains soda ash (e.g., sodium carbonate), resulting in the creation of a slurry, followed by the addition of a foaming agent resulting in the following materials by approximate weight in percentages: <<amorphous slag—80%; soda ash—12%; calcium hydroxide 7%; various remaining materials—1%>>. After the dry mix is added to the water, the hardening process begins. The fibers add flexural strength to the core when the slurry has hardened. Mixers of many varieties may be used, such as a pin mixer or continuous mixer, provided that the mix can be quickly removed from the mixer prior to hardening.

The foam can be premixed separately with water, typically in a foam generator, in a concentration of one-tenth of one percent (0.1%) to 5% foaming agent (i.e., surfactant) by weight to the combination of foaming agent and water, depending on the desired density. In one example twenty-five hundredths of one percent (0.25%) foaming agent by weight of the resulting combination of water and foaming agent is used. The gypsum wallboard industry typically uses two-tenths of one percent (0.2%) foaming agent by weight. The resulting foam is added to the wet mix in this example, and the foam is 0.02% by weight of the total weight of the entire mix. The amount of foam depends on the desired density and strength of the hardened core, with 0.01%-1% foam by weight being optimal. Examples of foam used in gypsum wallboards include those described in U.S. Pat. Nos. 5,240,639; 5,158,612; 4,678,515; 4,618,380; and 4,156,615, each of which is incorporated by reference herein in its entirety and for all purposes. The use of such agents is well known to those manufacturing gypsum wallboard and other cementitious products.

The slurry may be poured between two paper facings. However, versions may be made with or without paper on one or both sides. The hardening reaction will begin almost immediately after removal from the mixer. The resulting boards can form a finished product that may have strength characteristics similar to or greater than the strength characteristics of gypsum wallboards, and can be easily scored and snapped in the field. High density boards that are often used for tile backing and exterior applications do not exhibit many of the benefits of the wallboards processed in accordance with this process, such as low weight and satisfactory score and snap.

In various embodiments, a dry mix of powders is prepared by mixing amorphous blast furnace slag, crystalline blast furnace slag, calcium hydroxide, an accelerator and synthetic fibers to form the dry mix. The dry mix is then added to hot water that contains sodium carbonate. The processing of the slurry may occur using several different techniques depending on a number of factors, such as quantity of boards required, manufacturing space, and familiarity with the process by the current engineering staff. The normal gypsum slurry method using a conveyor system, which is a continuous line process that wraps the slurry in paper, is one acceptable method for fabricating the low embodied energy wallboards disclosed herein. This process is well known to those skilled in manufacturing gypsum wallboard. Also the Hatscheck method, which is used in cement or other high density board manufacturing, is acceptable to manufacture the wallboards disclosed herein. The Hatscheck method is particularly well suited to wallboards of the type disclosed herein that do not require paper facing or backing, and is well known to those skilled in the art of cement board manufacturing. Additional water can be required to thin the slurry when the Hatscheck method is used, because the manufacturing equipment used often requires a lower viscosity slurry. Alternatively, and as another manufacturing method, the slurry may be poured into pre-sized molds and allowed to set. Each board can then be removed from the mold, which can be reused.

Due to the inherent strength that can be achieved with a higher reactionary waste material composition to waste-based filler ratio, other cementitious objects can be formed that can be used in construction or potentially other fields. These objects may not be in the form of panels, but could be in the form of any cementitious objects normally made using Portland cement or other similar materials. Such objects can be poured and dried quickly, setting within a few minutes either in molds or on site.

### Alkali-Activated Hot Water Reaction

In some embodiments, hot water is combined with the dry mix including the industrial material and the alkali-activating agent, which results in the formation of cementitious components within the industrial material. The hot water can have a temperature ranging from about 20 C to 100 C. In some embodiments, the water can have a temperature of about 50 C or above. The reactions discussed here can use many of kinds of alkali-activating agents, which are well known in the industry as well as the minerals from which they are derived. Such agents include calcium oxide, magnesium oxide, potassium hydroxide, sodium hydroxide, calcium hydroxide, calcium carbonate, potassium carbonate, sodium carbonate, sodium sesquicarbonate (natural Trona ore), sodium silicate, calcium silicate, magnesium silicate or calcium aluminate, to name a few.

Many different configurations of materials may be provided in accordance with this disclosure. Such materials may result in improved strength, hardness, score/snap capability, paper adhesion, thermal resistance, impact, and fire resistance. The industrial materials herein can be compatible with many different additives including cornstarch, wheat starch, tapioca starch, potato starch, synthetic starch, naturally-occurring minerals, ceramic microspheres, foam, fibers and other low-embodied energy materials. Uncalcined gypsum may also be used as a filler, but is not required to form a cementitious wallboard core. By carefully choosing low-energy, plentiful, biodegradable materials as additives, such as those listed above, preferable wallboards can be manufactured that begin to take on the characteristics of gypsum wallboard. Characteristics such as weight, structural strength so as to be able to be carried, the ability to be scored and then broken along the score line, the ability to resist fire, and the ability to be nailed or otherwise attached to other materials such as studs, for example, are important to the marketplace and are required to make the product a commercial success as a gypsum wallboard replacement.

### Exothermic Reaction

In various embodiments, an exothermic reaction between the primary material components, such as industrial material, alkali-activating agent and room temperature water, naturally generates heat. As a result, a series of chemical reactions can be initiated to form cementitious components within the material. The exothermic reactions discussed here can use many of kinds of alkali-activating agents, which are well known in the industry as well as the minerals from which they are derived. Such alkali-activating agents include calcium oxide magnesium oxide, potassium hydroxide, sodium hydroxide, calcium hydroxide, calcium carbonate, potassium carbonate, sodium carbonate, sodium sesquicarbonate (natural Trona ore), sodium silicate, calcium silicate, magnesium silicate or calcium aluminate to name a few. For example, an exothermic reaction can be created in which a dry mix of amorphous and crystalline slag and calcium oxide is added to room temperature water containing sodium carbonate.

The exothermic reaction will begin almost immediately after removal from the mixer and continue for several hours, absorbing a portion of the water into the reaction. Boards can be cut and removed in less than thirty (30) minutes, and often less than five (5) minutes depending on requirements and handling equipment available. All of the water has not yet been used in the reaction, and some absorption of the water will continue for many hours. Within twenty-four to forty-eight (24-48) hours, the majority of water has been absorbed, with evaporation occurring as well. When paper facing is used, it is recommended that the boards be left to individually dry for 24 hours to provide air drying from both sides. This can be accomplished on racks or spacers at room temperature with no heat required. Drying may be faster at higher temperatures and slower at lower temperatures above freezing. Temperatures above 80° F. were tested but not considered since the design targets a low energy process. Residual drying will continue to increase at higher temperatures; however, it may not be beneficial to apply heat above room temperature due to the need of the exothermic reaction to utilize the water that would thus be evaporated too quickly.

The resulting boards or finished product may have strength characteristics similar to or greater than the strength characteristics of gypsum wallboards, and can be easily scored and snapped in the field. High density boards, which are often used for tile backing and exterior applications, do not exhibit many of the benefits of the wallboards processed in accordance with this disclosure such as low weight, satisfactory score and snap characteristics, and paper facing.

The reaction time of the resulting exothermic reactions can be also controlled by many factors including the total composition of slurry, the fillers in the slurry, the amount of water or other liquids in the slurry, the addition of a water reduction agent or the addition of a retarder or accelerator. Retarders can be added to slow down a reaction and may include any one or more of the following: boric acid, borax, sodium tripolyphosphate, sodium sulfonate, citric acid and many other commercial retardants common to the industry. Accelerators can be added to speed up the reaction and can include any one or more of the following materials such as sodium carbonate, potassium carbonate, potassium hydroxide, aluminum hydroxide, sodium hydroxide, calcium hydroxide, calcium chloride, calcium oxide, calcium nitrate, potassium nitrate, sodium trimetaphosphate, calcium formate, triethanolamine, Portland cement and other commercial accelerators common to the industry. Ideally, one should avoid the addition of Portland cement due to its high embodied energy.

Water reducers, sometimes called dispersants, are liquid additives that may inhibit flocking of particles so that homogenous particle distribution can be obtained without making additional water necessary. Water reducing agents are also well known in the industry, and examples include polysaccharides, lignosulfonates, napthlenesulfonates and polycarboxylates. These and other factors or additives may control or otherwise affect the reaction time for the exothermic reactions resulting from the manufacturing of wallboards provided herein.

FIG. 2 provides a flowchart of an exemplary method of manufacturing low embodied energy wallboards that require substantially less energy to produce according to one embodiment of the present disclosure. After a start step 200, an initial dry mix can be formed with an amorphous phase material at process step 201, after which an alkalai activating agent can be added to water at process step 202. The dry mix can then be added to the water and alkali to form a slurry at process step 203. An optional step 204 or optional step 205 or neither can be taken to add an accelerator on retarder to the slurry, so as to speed up or slow down the amount of time taken for the slurry to set. At a following optional process step 206, the slurry can be poured into mold(s) of a desired shape. The slurry is then allowed to set at step 207, and can optionally be cut into one or more desired shapes at process step 208. The method then ends with the final product formed at end step 209.

The wallboards can either be formed in molds or formed using a conveyor system of the type used to form gypsum wallboards and then cut to the desired size as more fully described in many of the references identified above.

As shown in the process of FIG. 2, while a slurry starts thickening quickly, an exothermic reaction can proceed to heat the slurry, such that eventually the slurry sets into a hard mass. Typically maximum temperatures during the exothermic reaction that can range from 35° C. to 55° C. have been observed depending on content and size of mix. The resulting hardness can also be controlled by the amount of naturally occurring fillers found in the post-industrial waste, and can vary from extremely hard and strong to soft (but dry) and easy to break. Other parameters such as set time, strength required to remove the boards from molds or from a continuous slurry line, can be varied from twenty (20) seconds to days, depending on the additives or fillers. For instance, boric acid can extend a set time from seconds to hours where powdered boric acid is added to the binder in a range of 0% (seconds) to 4% (hours). While a set time of twenty (20) seconds can lead to extreme productivity, the slurry may begin to set too soon for high quality manufacturing, and thus the set time should be adjusted to a longer period of time typically by adding boric acid or other applicable retarder. Other additives and factors described elsewhere herein can be utilized to control or manipulate set times.

It should be understood from the foregoing that, while particular implementations have been illustrated and described, various modifications can be made thereto and are contemplated herein. It is also not intended that the disclosure be limited by the specific examples provided within the specification. While the disclosure has been described with reference to the aforementioned specification, the descriptions and illustrations of the preferable embodiments herein are not meant to be construed in a limiting sense. Furthermore, it shall be understood that all aspects of the disclosure are not limited to the specific depictions, configurations or relative proportions set forth herein which depend upon a variety of conditions and variables. Various modifications in form and detail of the embodiments of the disclosure will be apparent to a person skilled in the art. It is therefore contemplated that the disclosure shall also cover any such modifications, variations and equivalents. Various changes and modifications may be practiced, and it is understood that the disclosure is not to be limited by the foregoing details, but rather is to be defined by the scope of the claims.

What is claimed is:

1. A wallboard, comprising:
at least one industrial material in an amorphous phase and selected from the group consisting of: slag, fly ash, silica fume, and lime kiln dust; and
at least one alkali-activating agent.

2. The wallboard of claim 1, wherein said alkali-activating agent comprises one or more materials selected from the group consisting of: calcium oxide, magnesium oxide, potassium hydroxide, sodium hydroxide, calcium hydroxide, calcium carbonate, potassium carbonate, sodium carbonate, sodium sesquicarbonate, sodium silicate, calcium silicate, magnesium silicate and calcium aluminate.

3. The wallboard of claim 1, further comprising:
water.

4. The wallboard of claim 1, further comprising:
fibers selected from the group consisting of: polyethylene fibers, polypropylene fibers, and other synthetic fibers.

5. The wallboard of claim 1, further comprising:
a foam filler.

6. The wallboard of claim 1, further comprising:
paper on one or both outer sides of the wallboard.

7. The wallboard of claim 1, further comprising:
at least one additional industrial material in a crystalline phase and selected from the group consisting of: slag, fly ash, silica fume, and lime kiln dust.

8. A method of fabricating a wallboard, comprising:
forming an dry mix comprising at least one industrial material in an amorphous phase, said industrial material being selected from the group consisting of slag, fly ash, silica fume, and lime kiln dust;
adding to water at least one alkali-activating agent, wherein said agent comprises one or more ingredients selected from the group consisting of: calcium oxide, magnesium oxide, potassium hydroxide, sodium hydroxide, calcium hydroxide, calcium carbonate, potassium carbonate, sodium carbonate, sodium sesquicarbonate, sodium silicate, calcium silicate, magnesium silicate and calcium aluminate;
adding the dry mix to the alkali and water to form a slurry; and
allowing the slurry to set.

9. The method of claim 8, further comprising the step of:
cutting the set slurry to a desired shape.

10. The method of claim 8, further comprising the step of:
adding a retarder material to the slurry, whereby the time taken for the slurry to set is increased.

11. The method of claim 8, further comprising the step of:
adding an accelerator material to the slurry, whereby the time taken for the slurry to set is decreased.

12. The method of claim 8, further comprising the step of:
pouring the slurry into a mold of a desired shape.
